(19) United States
(12) Patent Application Publication
(10) Pub. No.: US 2022/0060592 A1
(43) Pub. Date: Feb. 24, 2022

(54) OPERATION GUIDANCE ASSISTANCE SYSTEM AND METHOD FOR ASSISTING OPERATION GUIDANCE

(71) Applicant: SHARP KABUSHIKI KAISHA, Osaka (JP)

(72) Inventors: Masaki Kondo, Osaka (JP); Yoshinori Nagata, Osaka (JP); Yukako Nii, Osaka (JP); Miho Yamamura, Osaka (JP); Michiko Katsuki, Osaka (JP); Tadashi Noguchi, Osaka (JP); Masao Saeda, Osaka (JP)

(21) Appl. No.: 17/405,333

(22) Filed: Aug. 18, 2021

(30) Foreign Application Priority Data
Aug. 20, 2020 (JP) 2020-139529

(51) Int. Cl. H04N 1/00; G06K 9/00; G06K 9/46

(52) U.S. Cl. CPC H04N 1/00411; G06K 9/00355; G06K 9/4652; H04N 1/00076; H04N 1/00029

(57) ABSTRACT

An operation guidance assistance system includes a controller executing operation guidance of an image generation apparatus and a display displaying the operation guidance. The controller: obtains, when the image generation apparatus develops an error, information on a site of the error with an imaging apparatus; identifies a member-to-be-operated in accordance with the information on the site of the error in the image generation apparatus, the member-to-be-operated being a subject to the operation guidance for clearing the error; obtains, from the information on the site of the error, information on a hand of a user carrying out an operation of the image generation apparatus; displays, on the display, the information on the site of the error including the information on the hand of the user; and displays operation guidance assistance information to guide the user through the operation in accordance with a sequence of the operation guidance.

### CROSS-REFERENCE TO RELATED APPLICATION

The present application claims priority from Japanese Patent Application Number 2020-139529, the content to which is hereby incorporated by reference into this application.

### BACKGROUND OF THE INVENTION

### 1. Field of the Invention

An aspect of the present invention relates to operation guidance assistance systems and, in particular, to an operation guidance assistance system, for an image generation apparatus, operating with an imaging apparatus.

### 2. Description of the Related Art

When a user of a recent image generation apparatus known in the art refers to operation guidance and corrects an error of the apparatus, the display of the apparatus presents an item of the user's desire so that the user does not have to otherwise refer to, for example, an operating manual.

In the case where the known image generation apparatus develops an error, the user opens, for example, a side panel of the image generation apparatus, and operates components related to a cause of the error such as a handle, an operation button, and a gear in order to clear the error.

However, if two or more handles and operation buttons are found near the site of the error, the user would sometimes be confused about which ones to operate.

Moreover, even though the display presents operation guidance for clearing the error, the user might not understand what to do.

Hence, when a paper jam occurs in an image generation apparatus, a disclosed conventional technique gives the user guidance on an operation capable of appropriately clearing the paper jam in accordance with the condition of the paper jam. (See Japanese Unexamined Patent Application Publication No. 2013-205425).

Specifically, when the paper jam occurs in the image generation apparatus, the technique disclosed in Japanese Unexamined Patent Application Publication No. 2013-205425 presents in an understandable manner an operation to clear the paper jam in accordance with the condition of the paper jam. The technique involves obtaining an image of the site of the paper jam using a camera of a mobile terminal, and superimposing on the obtained image how to perform the operation.

### SUMMARY OF THE INVENTION

The technique disclosed in Japanese Unexamined Patent Application Publication No. 2013-205425 presents an operation on how to clear jammed paper, and determines with image recognition that the paper jam has been cleared when no jammed paper is found. However, the technique fails to give guidance on how to operate a handle and a lever to clear the paper jam.

Hence, the technique disclosed in Japanese Unexamined Patent Application Publication No. 2013-205425 is silent as to a conventional request of the users; that is, executing operation. guidance in an understandable manner so that, even if the apparatus develops an error, the users can easily clear the error.

In view of the above problem, an aspect of the present invention is intended to provide, for example, an operation guidance assistance system executing operation guidance of an image generation apparatus in an understandable manner so that, even if the image generation apparatus develops an error, the user can easily clear the error.

An operation guidance assistance system according to an aspect of the present invention is for an image generation apparatus, operating with an imaging apparatus (e.g. a camera). The operation guidance assistance system includes: a controller executing operation guidance of the image generation apparatus; and a display e.g. an operation screen) displaying the operation guidance. The controller: obtains, when the image generation apparatus develops an error, information (a picture) on a site of the error with the imaging apparatus; identifies a member-to-be-operated (e.g. an operation handle, an operation button, a conveyor, and a drive gear) in accordance with the information on the site of the error in the image generation apparatus, the member-to-be-operated. being a subject to the operation guidance for clearing the error; obtains, from the information on the site of the error, information on a hand of a user carrying out an operation of the image generation apparatus; displays, on the display, the information on the site of the error including the information on the hand of the user; and displays operation guidance assistance information to guide the user through the operation in accordance with a sequence of the operation guidance.

An operation guidance assistance system according to an aspect of the present invention is for an image generation apparatus, operating with an imaging apparatus. The operation guidance assistance system includes: a controller executing operation guidance of the image generation apparatus; and a display displaying the operation guidance. When a user requests operation guidance of the image generation apparatus, the controller: identifies a member-to-be-operated in accordance with information requested from the user, the member-to-be-operated being a subject to the operation guidance; obtains, with the imaging apparatus, information on a hand of the user operating the image generation apparatus; displays, on the display, information on the operation guidance including the information on the hand of the user; and displays operation guidance assistance information to guide the user through the operation in accordance with a sequence of the operation guidance.

A method for assisting operation guidance, with an imaging apparatus, according to an aspect of the present invention is for an image generating apparatus. The method includes: obtaining, when the image generation apparatus develops an error, information (a picture) on site of the error with the imaging apparatus; identifying a member-to-be-operated in accordance with the information on the site of the error in the image generation apparatus, the member-to-be-operated being a subject to the operation guidance for clearing the error; obtaining, from the information on the site of the error, information on a hand of a user carrying out an operation of the image generation apparatus; displaying the information on the site of the error including the information on the hand of the user; and displaying operation guidance assistance information to guide the user through the operation in accordance with a sequence of the operation guidance.

A method for assisting operation guidance, with an imaging apparatus, according to an aspect of the present invention is for an image generation apparatus. When a user requests operation guidance of the image generation apparatus, the method includes: identifying a member-to-he-operated in accordance with information requested from the user, the member-to-be-operated being a subject to the operation guidance; obtaining, with the imaging apparatus, information on a hand of the user operating the image generation apparatus; displaying, on the display (an operation screen), information on the operation guidance including the information on the hand of the user; and displaying operation guidance assistance information to guide the user through the operation in accordance with a sequence of the operation guidance.

When the operation guidance is executed for the image generation apparatus, the operation guidance assistance system according to an aspect of the present invention displays on the display: the information on the operation guidance; the information on a hand of the user carrying out the operation; and, in addition to the information on the operation guidance to be displayed on the display, the operation guidance assistance information to guide the user through the operation, in accordance with the sequence of the operation guidance. Such features make it possible to execute the operation guidance clearly for the user. For example, even if the apparatus develops an error, the operation guidance is executed while the display displays, for the user, a site of the error, the hand of the user carrying out the operation, and the operation guidance assistance information. Such a feature allows the user to easily clear the error.

### BRIEF DESCRIPTION OF THE DRAWINGS

FIG. 1 is a drawing illustrating an overall configuration of an operation guidance assistance system according to a first embodiment;

FIG. 2 is a drawing illustrating an assistance guidance operation of the operation guidance assistance system, using a mobile terminal apparatus;

FIG. 3 is a drawing illustrating an overall configuration of an image generation apparatus included in the operation guidance assistance system;

FIG. 4 is a block diagram illustrating a configuration of the image generation apparatus;

FIG. 5 is a block diagram illustrating an example of an operation guidance assistance function executed by a controller of the image generation apparatus;

FIG. 6 is a drawing illustrating an overall configuration of a mobile terminal apparatus included in the operation guidance assistance system;

FIG. 7 is a block diagram illustrating a configuration of the mobile terminal apparatus;

FIG. 8 is a flowchart illustrating an example of a sequence of operation guidance to be executed in the operation guidance assistance system;

FIG. 9 is an illustration showing an example of operation guidance assistance information to be displayed on a display of the mobile terminal apparatus;

FIG. 10 is an illustration showing an example of operation guidance assistance information to be displayed subsequently to FIG. 9;

FIG. 11 is an illustration showing an example of operation guidance assistance information to be displayed on the display of the mobile terminal apparatus according to a second embodiment;

FIG. 12 is an illustration showing an example of operation guidance assistance information to be displayed subsequently to FIG. 11;

FIG. 13 is a flowchart illustrating a portion of a sequence of operation guidance to be executed in an operation guidance assistance system according to a third embodiment;

FIG. 14 is a flowchart illustrating a sequence of operation guidance subsequent to FIG. 13;

FIG. 15 is a block diagram illustrating a configuration of an image generation according to a fourth embodiment; and

FIG. 16 is a block diagram illustrating an example of an operation guidance assistance function executed by a controller of the image generation apparatus.

### DETAILED DESCRIPTION OF THE INVENTION

### First Embodiment

Described below is a first embodiment of the present invention, with reference to the drawings.

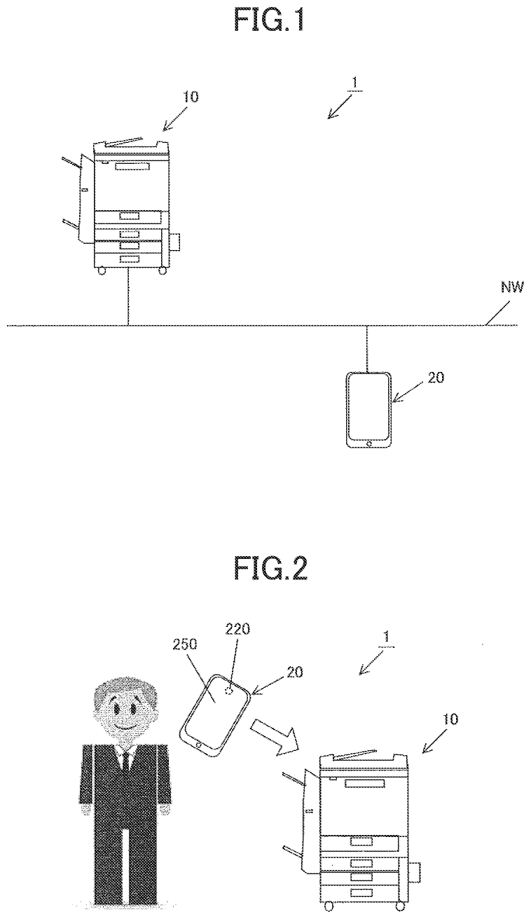

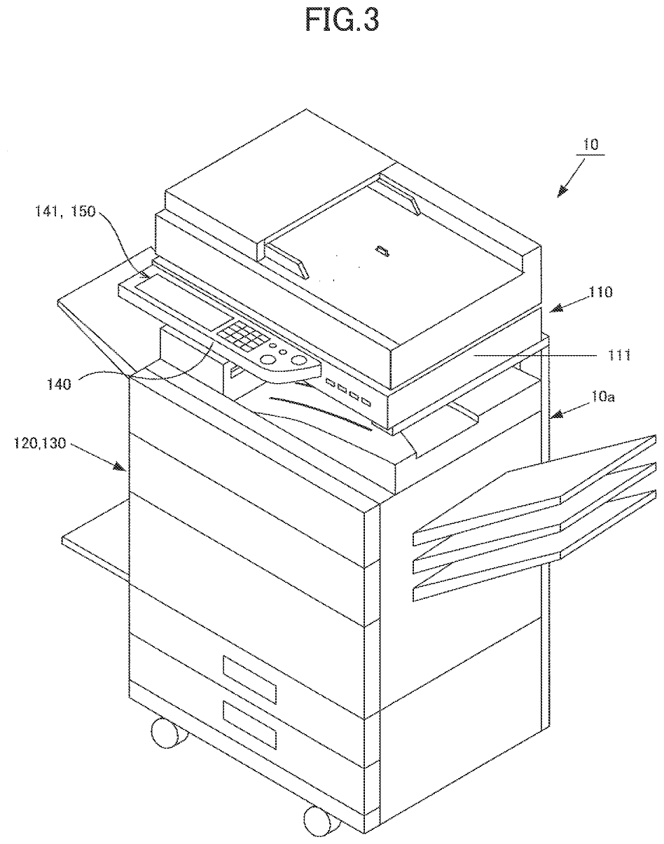

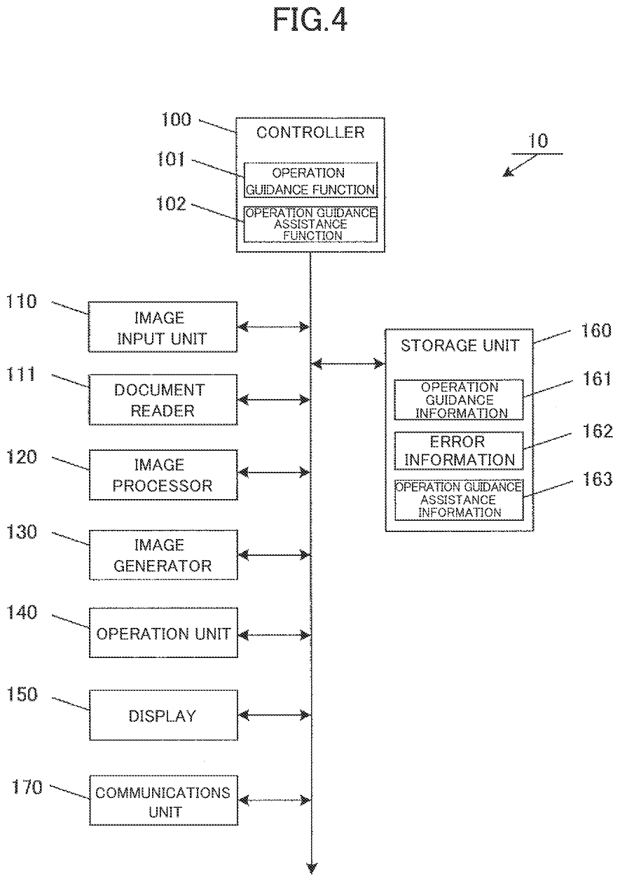

FIG. 1, showing an example of an embodiment of the present invention, is a drawing illustrating an overall configuration of an operation guidance assistance system according to the first embodiment of the present invention. FIG. 2 is a drawing illustrating an assistance guidance operation of the operation guidance assistance system, using a mobile terminal apparatus. FIG. 3 is a drawing illustrating art overall configuration of an image generation apparatus included in the operation guidance assistance system. FIG. 4 is a block diagram illustrating a configuration of the image generation apparatus. FIG. 5 is a block diagram illustrating an example of an operation guidance assistance function executed by a controller of the image generation apparatus.

### Configuration of Operation Guidance Assistance System

As illustrated in FIG-. 1, the first embodiment is directed to an operation guidance assistance system 1 including an image generation apparatus 10 and a mobile terminal apparatus 20 connected to each other to communicate through a network NW.

The image generation apparatus 10 in the operation guidance assistance system 1 is capable of executing operation guidance including guidance for operating the image generation apparatus 10 and guidance for clearing an error developed in the image generation apparatus 10.

As illustrated in FIG. 2, the mobile terminal apparatus 20 in the operation guidance assistance system 1 includes: a camera (an imaging apparatus) 220; and a display 250 displaying a picture obtained with the camera 220.

When the image generation apparatus 10 develops an error, the operation guidance assistance system 1 (i) identifies a site of the developed error in accordance with information on the error of the image generation apparatus 10, (ii) identifies a member-to-be-operated to be a subject to operation guidance for clearing the error, (iii) obtains information on a hand of a user carrying out the operation at the site, of the error developed in the image generation apparatus 10, captured with the camera 220 of the mobile terminal apparatus 20, (iv) displays, on the display 250 of the mobile terminal apparatus 20, information on the site of the error including information on the member-to-be-operated and the hand of the user, and (v) displays operation guidance assistance information to guide the user through the operation in accordance with a sequence of the operation guidance.

### Configuration of Image Generation Apparatus

Described first is an overall configuration of the image generation apparatus 10 according to the first embodiment.

As illustrated in FIG, 3, the image generation apparatus 10, a multifunction printer, includes: an apparatus body 10a; and a document reader 111 above the apparatus body 10a. The image generation apparatus 10 causes the document reader 111 to read an Image of a document, and outputs the read image by etectrophotography.

As illustrated in FIG. 4, the image generation apparatus 10 mainly includes: a controller 100; an image input unit 110; the document reader 111; an image processor 120; an image generator 130; an operation unit 140; a display 150; a storage unit 160; and a communications 110 unit 170.

The controller 100 is a functional unit to control the entire image generation apparatus 10.

The controller 100 reads and executes various programs to achieve various functions. An example of the controller 100 includes one or more computing units (e.g. a central processing unit; namely, a CPU).

The image input unit 110 is a functional to read image data to be input to the image generation apparatus 10. The image input unit 110 is connected to the document reader 111, a functional unit to read an image of a document, and inputs data of the read image to be output from the document reader 111.

The image input unit 110 may also input the image data from such storage media as a USB memory and an SD card. Moreover, the image input unit 110 may input the image data from another mobile terminal apparatus through the communications unit 170 that establishes connection with the other mobile terminal apparatus.

The document reader 111 optically scans a document placed on a not-shown contact glass, and sends the scanned data to the image generator 130.

The image processor 120 converts the image data read by the document reader 111 into a set file format (e.g. TIFF, GIF, and JPEG). After that, the image processor 120 generates an image to be output in accordance with the image data subjected to the image processing.

The image generator 130 is a functional unit to generate output data, based on the image data, in a recording medium (e.g. on a recording paper sheet). An example of the image generator 130 includes a laser printer utilizing electrophotography.

The operation unit 140 is a functional unit to receive an instruction of an operation by the user. The operation unit 140 includes various key switches and a device to detect an input through contact. Through the operation unit 140, the user inputs a function to use and an output condition.

The display 150 is a functional unit to display various kinds of information. The display unit 150 is, for example, a liquid crystal display (LCD).

That is, the operation unit 140 presents a user interface for operating the image generation apparatus 10, and the display 150 displays a message and a menu screen for various settings.

Note that the image generation apparatus 10 illustrated in FIG. 3 may include, as the operation unit 140, a touch panel as a combination of the operation panel 141 and the display 150. In such a case, exemplary techniques to detect an input on the touch panel may be typical ones utilizing resistive film, infrared, electromagnetic induction, and capacitance.

The storage unit 160 is a functional unit to store various programs including a control program required tier operations of the image generation apparatus 10, various kinds of data including read data, and user information. The storage unit 160 includes, for example, a non-volatile read-only memory (ROM), a non-volatile random-access memory (RAM), and a hard disk drive (HDD). Moreover, the storage memory 16( )may include a solid state drive (SSD); namely, a semiconductor memory.

The ROM stores a computer program for implementing typical operations of the image generation apparatus 10. The ROM further stores screen data for displaying, for example, various setting screens on the operation unit 140.

The RAM serves as a working memory to temporarily store a result of calculation processing executed on the CPU, and as a frame memory to store image data.

The HDD temporarily stores various kinds of data including the image data scanned with the document reader 111.

The communications unit 170 connects to, and establishes communications with, such an apparatus as the mobile terminal apparatus 20 through the network NW.

### Characteristic Configuration of Image Generation Apparatus

In the image generation apparatus 10 of the operation guidance assistance system 1 according to the first embodiment, the controller 100 illustrated in FIG. 4 includes: an operation guidance function 101; and an operation guidance assistance function 102.

When the image generation apparatus 10 develops an error, for example, the operation guidance function 101 executes operation guidance for clearing the error in accordance with information on the error of the image generation apparatus 10.

The operation guidance assistance function 102 assists the operation guidance function 101. As illustrated in FIG. 5 the operation guidance assistance function 102 includes:
(1) a function 1021 (hereinafter referred to as “a member-to-be-operated identification function”) to identify such a member-to-be-operated as an operation lever and a handle to be subjects to the operation guidance for clearing the error, in accordance with the error information on the image generation apparatus 10;
(2) a function 1022 (hereinafter referred to as “a user information obtainment function”) to obtain information on a hand of a user operating the image generation apparatus 10 captured with the camera 220 of the mobile terminal apparatus 20;
(3) a function 1023 (hereinafter referred to as “an error information display function”) to display on the display 250 information on a site of the error developed, including information on the hand of the user; and
(4) a function 1024 (hereinafter referred to as “an operation guidance assistance information display function”) to display on the display 250 operation guidance assistance information to guide the user through the operation, in addition to the information on the site of the developed error, in accordance with a sequence of the operation guidance for clearing the error.

In the first embodiment, as illustrated in FIG. 4, the storage unit 160 stores information including: operation guidance information 161; error information 162; and operation guidance assistance information 163.

The storage unit 160 previously stores, as the operation guidance information 161, information on executing the operation guidance of the image generation apparatus 10.

The storage unit 160 stores, as the error information 162, information on an error detected with a not-shown error detection sensor and information on a site of the error based on the information on the detected error.

The information on the site of the error includes position information on the error site and a cause of the error (such as a paper jam and a broken component).

The operation guidance assistance information 163 includes for example: image information indicating a member-to-be-operated; image information indicating a sequence of the operation; image information (i.e. an arrow indicating an operation direction (to push, to pull, and to turn) of the member-to-be-operated; and a caption for the sequence of the operation.

The member-to-be-operated includes: an operation member such as an operation handle; an operation button such as a touch key; and a drive member such as a gear.

### Configuration of Mobile Terminal Apparatus

Described next is the mobile terminal apparatus 20 according to the first embodiment, with reference to the drawings.

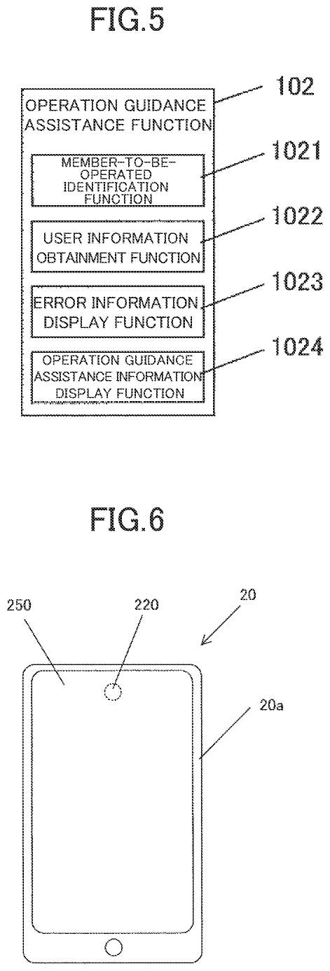

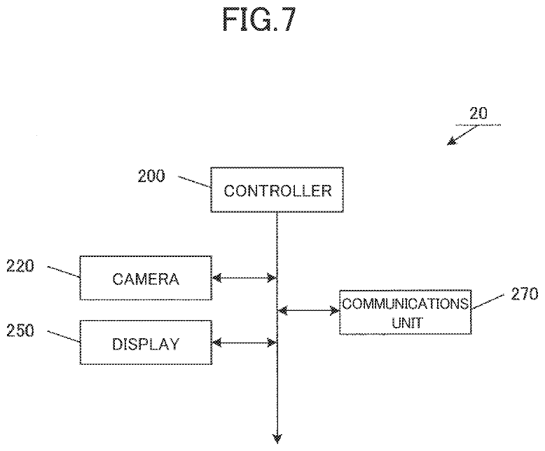

FIG. 6 is a drawing illustrating an overall configuration of a mobile terminal apparatus included in the operation guidance assistance system. FIG. 7 is a block diagram illustrating a configuration of the mobile terminal apparatus.

As illustrated in FIG. 6, the mobile terminal apparatus 20 includes: a body 20a; the display 250 provided to a front face of the body 20a; and the camera 220 provided to a rear face of the body 20a.

As illustrated in FIG. 7, the mobile terminal apparatus 20 mainly includes: a controller 200; the camera 220; the display 250; and a communications unit 270.

The mobile terminal apparatus 20 connects to, and establishes communication with, the image generation apparatus 10 through the communications unit 270. The display 250 displays an image captured with the camera 220, and the operation guidance information 161 and the operation guidance assistance information 163 from the image generation apparatus 10.

### Sequence of Operation Guidance

Described next with reference to a flowchart is an example of a sequence of the operation guidance, of the image generation apparatus 10, to be executed in the operation guidance assistance system 1.

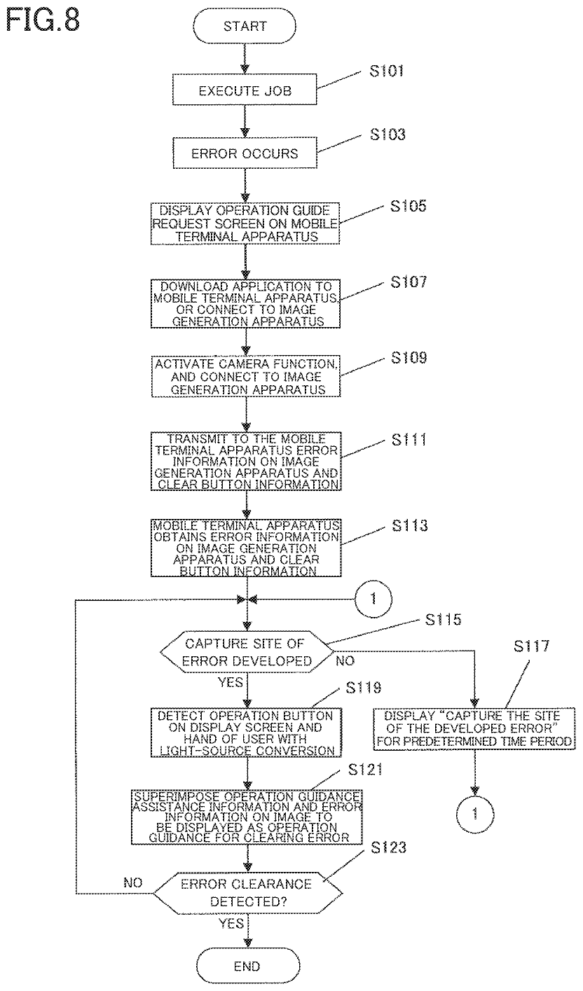

FIG. 8 is a flowchart illustrating an example of a sequence of operation guidance to be executed in the operation guidance assistance system according to the first embodiment.

Described here is a case where the operation guidance assistance system 1 executes the operation guidance using the mobile terminal apparatus 20, when the image generation apparatus 10 develops an error.

As shown in FIG. 8, at Step S101, the image generation apparatus 10 executes a print job. At Step S103, an error occurs. When the user carries out the operation guidance using the mobile terminal apparatus 20, at Step S1135, the display 250 of the mobile terminal apparatus 20 displays an operation guide request screen for the user to cam out the operation guidance.

Here, the operation guide request screen is an operation screen that enables the operation guidance assistance function when, for example, the user requests or selects an operation guidance assistance.

When the user carries out the operation guidance using the mobile terminal apparatus 20, at Step S107, the user either installs in the mobile terminal apparatus 20 an application for carrying out the operation guidance and starts the operation guidance, or connects the mobile terminal apparatus 20 to the image generation apparatus 10 and starts the operation guidance.

At Step S109, the user activates the camera 220 of the mobile terminal apparatus 20, and connects the mobile terminal apparatus 20 to the image generation apparatus 10.

At Step S111, the image generation apparatus 10 transmits to the mobile terminal apparatus 20 the error information 162, and the operation guidance assistance information 163 for clearing the error.

At Step S113, the mobile terminal apparatus 20 obtains the error information 162 and the operation guidance assistance information 163 on the image generation apparatus 10.

At Step S115, the operation guidance assistance system 1 determines whether the camera has captured a site of the error developed in the image generation apparatus 10.

If the operation guidance assistance system I determines at Step S115 that the camera 220 has not captured the site of the error, the operation guidance assistance system 1 causes at Step S117 the display 250 of the mobile terminal apparatus 20 to display, for a predetermined time period, a message to read, for example, “Capture the site of the developed error” in order to instruct the user to capture the site of the developed error. The process returns to Step S115.

Meanwhile, if the operation guidance assistance system 1 determines at Step S115 that the camera 220 has captured the site of the error, the operation guidance assistance system 1 detects at Step S119 an operation handle, an operation button, and a gear related to the captured site of the error, and a hand of the user carrying out the operation, utilizing such a technique as light-source conversion.

At Step S121, the operation guidance assistance system 1 superimposes on the error information the operation guidance assistance information 163 converted into an image showing the operation handle, the operation button, the gear, and the hand of the user carrying out the operation. The operation guidance assistance system 1 causes the display 250 to display the error information on the operation screen thereof to execute the operation guidance for clearing the error.

In displaying the operation guidance assistance information 163 on the operation screen, the images of the operation handle, the operation button, and the gear may be presented in color. A direction of the operation may be presented in an arrow. The operation guidance may be presented in a form of, for example, a comment.

The user carries out the operation in accordance with the operation guidance for clearing the error. When the error detection sensor of the image generation apparatus 10 detects no error condition, the error is cleared.

At Step S123, the operation guidance assistance system 1 determines whether the clearance of the error is detected in the image generation apparatus 10.

If the operation guidance assistance system 1 determines that the error clearance is not detected, the process returns to Step S115.

Meanwhile, if the operation guidance assistance system 1 determines at Step S123 that the error clearance is detected, the operation guidance for clearing the error ends.

After the operation guidance ends, the display screen of the display 250 may return to a previously set screen such as an initial screen and a normal operation screen.

### Example of Operation Guidance for Clearing Error

Described next is presentation of the operation guidance assistance information 163 to be displayed on the display 250 of the mobile terminal apparatus 20 according to the first embodiment, with reference to the drawings.

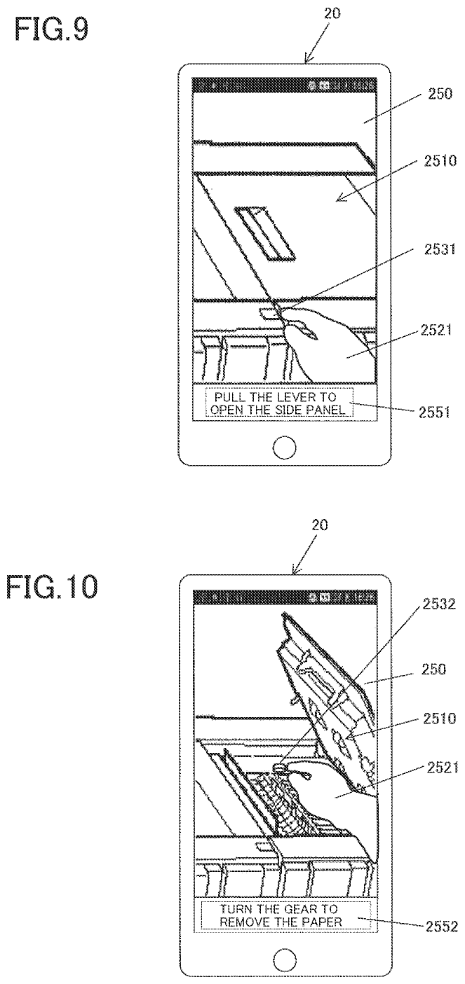

FIG. 9 is an illustration showing an example of operation guidance assistance information to be displayed on a display of the mobile terminal apparatus according to the first embodiment. FIG. 10 is an illustration showing an example of operation guidance assistance information to be displayed subsequently to FIG. 9.

In the first embodiment, when the operation guidance starts in the operation guidance assistance system 1, using the display 250 of the mobile terminal apparatus 20, the display 250 displays an error information image showing a site of an error developed in the image generation apparatus 10, and, as the operation guidance assistance information 163, an image of a hand of the user carrying out an operation, an image showing a member-to-be-operated in relation to clearance of the error, and a comment explaining an operation to clear the error.

Specifically, in the first embodiment, images illustrated in FIG. 9 are superimposed and displayed on an error information image 2510. The images includes: an operating hand image 2521 as an image of a hand of the user carrying out the operation; and an operation lever image 2531 as an image showing a member-to-be-operated in relation to the clearance of the error.

The operation lever image 2531, subjected to the superimposition processing, is displayed differently in color from other operation members not in relation to the error clearance to be carried out. For example, the operation lever image 2531 may be displayed in color, and the other operation members may be displayed in black and white.

As a comment to explain the operation to clear the error, a first guide comment 2551 to read “Pull the lever to open the side panel” is displayed near the error information image 2510. Here, the first guide comment 2551 is displayed in the display 250 at the bottom.

Note that the position of the first guide comment 2551 to be displayed is not limited to the bottom. Alternatively, the position of the first guide comment 2551 may be other than the bottom.

When a step of the operation to clear the error ends, a gear image 2532 illustrated in FIG. 10 is displayed to show a member-to-be-operated in relation to the next operation to clear the error.

Then, a second guide comment 2552, which reads “Turn the gear to remove the paper”, is displayed to explain an operation in this step to clear the error.

As can be seen, the display 250 of the mobile terminal apparatus 20 displays the error information image 2510, and additionally displays the operation guidance assistance information 163 including: the operating hand image 2521 of a hand of the user carrying out the operation; the operation lever image 2531; the gear image 2532; the first guide comment 2551; and the second guide comment 2552. Such a feature makes it possible to clarify a member-to-be-operated for the operation to clear the error, and to facilitate the operation to clear the error.

Note that, in accordance with the operating hand image 2521, the operation lever image 2531, the gear image 2532, the first guide comment 2551, and the second guide comment 2552 displayed as the operation guidance assistance information 163, the details of the operation carried out by the user may be stored in the storage unit 160 as operation history data of the operation guidance assistance information 163. In accordance with the operation history data, a subsequent operation guidance may be executed.

Thanks to the above configuration, the first embodiment is directed to the operation guidance assistance system 1 of the image generation apparatus 10, using the camera of the mobile terminal apparatus 20. The image generation apparatus 10 includes: the operation guidance function 101; and the operation guidance assistance function 102. When the image generation apparatus 10 develops an error, the operation guidance assistance system 1 (i) uses the display 250 of the mobile terminal apparatus 20 as a display to present operation guidance, and identifies a member-to-be-operated to be a subject to the operation guidance for clearing the error in accordance with information on the error of the image generation apparatus 10, (ii) displays on the display 25( )the error information image 2510 captured with the camera 220 and the operation guidance assistance information 163 including the operating hand image 2521 showing a hand of the user, and (iii) guides the user through the operation in accordance with a sequence of the operation guidance for clearing the error. Such features make it possible for the user to easily carry out an operation to clear the error.

In the first embodiment, the operation guidance assistance information 163 includes the operating hand image 2521 showing a hand of the user, and additionally includes: the operation lever image 2531 and the gear image 2532 as images to show members-to-be-operated in relation to the clearance of the error; and the second guide comment 2552 as a comment to explain the members-to-be-operated in relation to the clearance of the error. Such features make it possible for the user to operate with no mistake the members-to-be-operated for the clearance of the error.

Moreover, in the first embodiment, the operation ever image 2531 is displayed differently in color from another member-to-be-operated not in relation to the clearance of the error. Such a feature allows the user to distinguish a member-to-be-operated.

Note that the first embodiment describes that, when image generation apparatus 10 of the operation guidance assistance system 1 develops an error, the operation guidance assistance function 102 assists the operation guidance for clearing the error. However, the operation guidance assistance function 102 shall not be limited to the assistance to the operation guidance for the clearance of the error. For example, in accordance with information on the operation guidance requested by the user of the image generation apparatus 10, the operation guidance assistance function 102 may provide assistance to the requested operation guidance.

### Second Embodiment

Described next is a second embodiment.

In the second embodiment, the operation guidance assistance system 1: distinguishes an image region, of information obtained by the camera 220, based on a difference in color by light-source conversion using, for example, a CMOS sensor to identify a member-to-be-operated and a hand of a user; and, in executing operation guidance for clearing an error, displays a guidance image (such as a marker and an arrow) on the display 250, in association with a positional relationship between the member-to-be-operated and the hand of the user carrying out the operation, to guide the user through the operation.

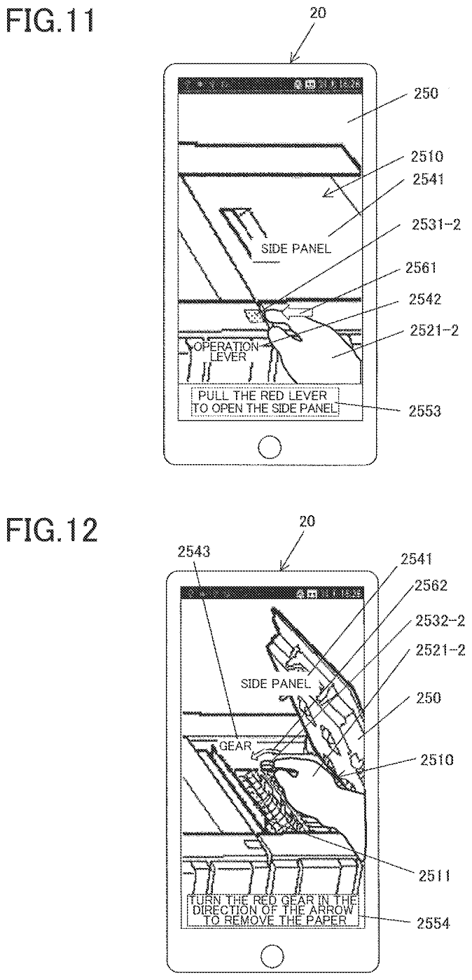

FIG. 11 is an illustration showing an example of operation guidance assistance information to be displayed on the display of the mobile terminal apparatus according to the second embodiment. FIG. 12 is an illustration showing an example of operation guidance assistance information to be displayed subsequently to FIG. 11.

Note that, for the sake of description, identical reference signs are used to denote identical components of the operation guidance assistance system between the first and second embodiments. Details of such components will not be elaborated upon here.

In the second embodiment, the operation guidance assistance system 1 presents as the operation guidance assistance information 163 an image of a hand of a user carrying out an operation, an image showing a member-to-be-operated in relation to clearance of an error, and a comment explaining an operation to clear the error. The operation guidance assistance system 1 further presents a comment explaining the member-to-be-operated in relation to the clearance of the error.

Specifically, in the second embodiment, images illustrated in FIGS. 11 and 12 are superimposed and displayed on the error information image 2510. The images include: an operating hand image 2521-2 as an image of a hand of the user carrying out the operation; an operation lever image 2531-2 and a gear image 2532-2 as images showing members-to-be-operated in relation to the clearance of the error; and names of such members-to-be-operated as a side panel 2541, an operation lever 2542, and a gear 2543 as comments explaining the members-to-be-operated in relation to the clearance of the error.

Moreover, in the second embodiment, the images to be displayed on the display 250 are presented in different colors depending on image regions, utilizing light-source conversion.

Specifically, as illustrated in FIGS. 11 and 12, the operating hand image 2521-2 is in yellow, the operation lever image 2531-2 and the gear image 2532-2 are in red, and an inside 2511 of the image generation apparatus 10 is in black.

As can be seen, images to be displayed on the display 250 or image regions in which the images are displayed are presented in different colors, depending the images or the image regions. Such a feature allows the user to identify each of the images by color.

In the second embodiment, in executing operation guidance for clearing an error, an arrow 2561 in FIG. 11 is displayed as a guidance image in association with a positional relationship between the operation lever image 2531-2 and the operating hand image 2521-2, in order to guide the user through the operation.

Hence, the direction of the arrow 2561 can clearly show the user in which direction he or she operates the operation lever 2542.

Moreover, as a guide for the user to show on the gear image 2531-2 how to operate the gear 2543, an arrow 2562 in FIG. 12 is displayed as a guidance image for suggesting rotation of the gear 2541.

Hence, the arrow 2562 suggesting the rotation of the gear 2543 can clearly show the user what operation he or she is supposed to carry out.

As a comment to explain the operation to clear the error, in FIG. 11, a third guide comment 2553 is displayed to read “Pull the red lever to open the side panel.” Furthermore, in FIG. 12, a fourth guide comment 2554 is displayed to read “Turn the red gear in the direction of the arrow to remove the paper.”

Such features allows for setting colors of such members-to-be-operated as the operation lever and the gear, and for displaying such a guidance image as an arrow, making it possible to further clarify a member-to-be-operated in the operation to clear the error, and to facilitate the operation to clear the error.

Thanks to the above configuration, the operation guidance assistance system 1 according to the second embodiment, distinguishes an image region in color when the display 250 displays the information guidance assistance information 163. Such a feature allows for identification of images, of a member-to-be-operated and a hand of the user, captured by the camera 220, and allows, in executing operation guidance for clearing an error, for display of such a guidance image as an arrow, in association with a positional relationship between the member-to-be-operated and the hand of the user carrying out the operation, to guide the user through the operation. Hence, the feature makes it possible to more clearly present the operation guidance to the user.

Furthermore, the operation guidance assistance system 1 causes the image generation apparatus 10 to store position information on such an operation member as the operation lever of the image generation apparatus 10. When the display 250 displays color-coded images of members-to-be-operated, such a feature makes it possible to present more precisely positions of the images, of the error information and of a member-to-be-operated, to be displayed on the display 250.

Note that, in the second embodiment, the arrows 2561 and 2562 are displayed as the guidance images near the operation lever image 2531-2 and the gear image 2532-2; namely, images of the members-to-be-operated. Alternatively, the guidance images may be presented in any given manner.

For example, as modifications, the guidance images may be changed in presentation in such manners as blinking, different coloring, and changing the directions of the arrows, to correspond to a change in positional relationship between an operating hand image of a hand of the user and an image of a member-to-be-operated.

Moreover, as another example, the error information image 2510 may be provided, near or above thereof, with such captions as step 1, step 2 . . . , and step numbers such as step 1/5, step 2/5 . . . .

### Third Embodiment

Described next is a third embodiment.

In the operation guidance assistance system 1 of a third embodiment, the mobile terminal apparatus 20 is capable of pausing a picture for operation guidance to be displayed on the display 250 when the camera 220 captures a site of an error during an operation to clear the error. When the paused operation guidance is resumed, the mobile terminal apparatus 20 recognizes positions of a member-to-be-operated and of a hand of a user, and resumes the operation guidance at the pause of the operation guidance.

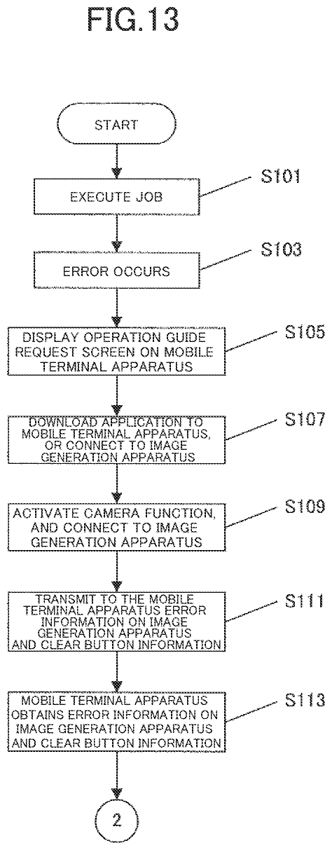

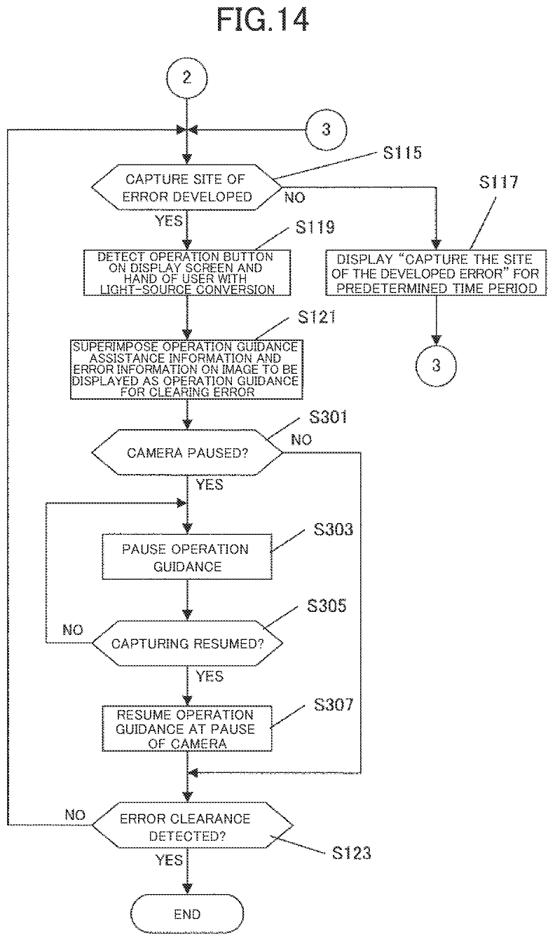

FIG. 13 is a flowchart illustrating a portion of a sequence of operation guidance to be executed in an operation guidance assistance system according to a third embodiment. FIG. 14 is a flowchart illustrating a sequence of operation guidance subsequent to FIG. 13.

Note that the operation guidance assistance system according to the third embodiment is similar in configuration to, and is described with reference to, the operation guidance assistance system 1 according to the first embodiment. Hence, the details of the operation guidance assistance system according to this embodiment will not be elaborated upon here.

Described here in accordance with the flowchart is a case where, in the operation guidance assistance system 1, the camera 220 of the mobile terminal apparatus 20 suspends capturing a site of an error developed in the image generation apparatus 10 when an operation is carried out to clear the error.

Note that, in the operation guidance assistance system 1 according to the third embodiment, processing to execute operation guidance other than suspending the capturing with the camera 220 of the mobile terminal apparatus 20 and carrying out an operation to clear the error; that is, processing from Steps S101 to S123 shown in FIGS. 13 and 14, is carried out in a similar manner as the processing in the operation guidance of the operation guidance assistance system 1 according to the first embodiment. Hence, the description thereof shall be omitted.

Thus, described here is processing, of the operation guidance assistance system 1, in which capturing with the camera 220 of the mobile terminal apparatus 20 is suspended and an operation to clear the error is carried out.

As illustrated in FIG, 14, the operation guidance assistance system 1 according to the third embodiment superimposes, at Step S121, the operation guidance assistance information 163 on error information and displays the error information on the display 250. If the user has to pause the camera 220 When the operation guidance is executed for clearing the error because of a situation in the operation, and pauses the camera 220, the operation guidance assistance system 1 determines at Step S301 whether the camera 220 is paused.

If the determination indicates at Step S301 that the camera is paused, the operation guidance assistance system 1 pauses at Step S303 a screen tier the operation guidance to be displayed on the display 250.

At Step S305, the operation guidance assistance system 1 determines whether the capturing with the camera 220 is resumed. If the determination indicates that the capturing with the camera 220 is resumed, the operation guidance assistance system 1 resumes at Step S307 the operation guidance for clearing the error at the pause of the camera 220. The processing proceeds to Step S123.

Meanwhile, if the determination indicates at Step S305 that the capturing with the camera 223 is not resumed, the processing returns to Step S303.

Moreover, if the determination indicates that the camera 220 is not paused, the processing proceeds to Step S123.

This is how the operation guide is executed.

Thanks to the above configuration of the operation guidance assistance system 1 according to the third embodiment, When the operation guidance paused is resumed to be displayed on the display 250 in capturing the site of an error with the camera 220 during the operation to clear the error, the mobile terminal apparatus 20 recognizes positions of a member-to-be-operated and of a hand of the user and resumes the operation guidance at the pause of the operation guidance. When, for example, the user has to use both of his or her hands while checking on the camera 220 a sequence of clearing the error, the guidance for the operation sequence is paused, making it possible for the user to smoothly carry out the operation to clear the error.

Note that, when the operation guidance is resumed, the camera 220 of the mobile terminal apparatus 20 may be positioned again at the site of the error, resume the capturing of the site, and obtain information on the site of the error to determine that the operation guidance should be resumed.

### Fourth Embodiment

Described next is a fourth embodiment.

In the operation guidance assistance system 1 of the fourth embodiment, the image generation apparatus 10, which includes the operation guidance assistance function 102 of the controller 100, additionally includes a function to notify a user to capture the image generation apparatus 10 if the operation guidance assistance system 1 cannot recognize the image generation apparatus 10 when the camera 220 captures a site of an error.

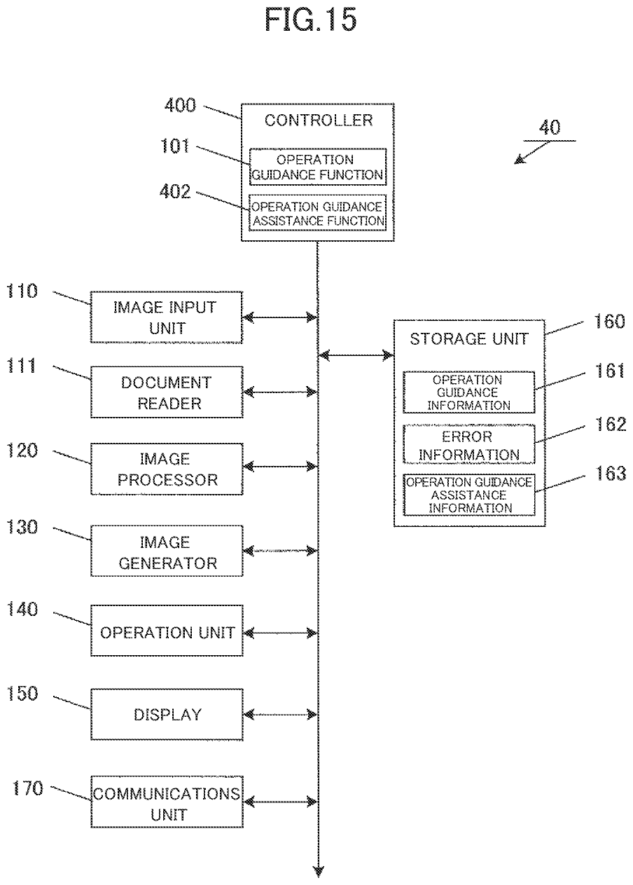

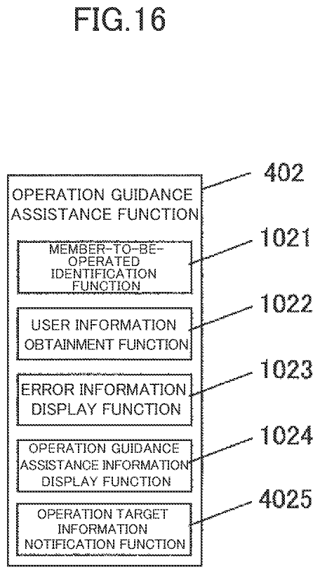

FIG. 15 is a block diagram illustrating a configuration of an image generation apparatus according to the fourth embodiment. FIG. 16 is a block diagram illustrating an example of an operation guidance assistance function executed by a controller of the image generation apparatus.

Note that identical reference signs are used to denote identical or substantially identical features between the image generation apparatuses of the first and fourth embodiments. Such features will not be elaborated upon here.

As illustrated in FIG. 15, an image generation apparatus 40 of the operation guidance assistance system 1 according to the fourth embodiment includes a controller 400. The controller 400 includes: the operation guidance function 101; and an operation guidance assistance function 402.

As illustrated in FIG. 16, the operation guidance assistance function 402 includes: the member-to-be-operated identification function 1021; the user information obtainment function 1022; the error information display function 1023; and the operation guidance assistance information display function 1024. The operation guidance assistance function 402 additionally includes an operation target information notification function 4025.

If the image generation apparatus 40 to be operated is not captured with the camera 220, the operation guidance assistance function 402 of the fourth embodiment allows the operation target information notification function 4025 to cause the display 250 to display, for example, a comment informing the user to capture the image generation apparatus 40 with the camera 220. Hence, the operation guidance assistance function 402 notifies the user that the image generation apparatus 40 is not captured.

Moreover, if the controller 400 notifies the user that the image generation apparatus 40 should be captured, and, after that, recognizes the image generation apparatus 40 by the information transmitted from the camera 220, the controller 400 may recognize positions of the image generation apparatus 40 and of a hand of the user operating the camera 220, and guide the user through the operation in accordance with the operation guidance.

Thanks to the above configuration, in the operation guidance assistance system 1 of the fourth embodiment, if the image generation apparatus 40 to be a subject to the operation guidance is not displayed on the display 250 when the operation guidance of the image generation apparatus 40 is executed, the operation guidance assistance function 402 notifies the user to capture the image generation apparatus 40. Such a feature makes it possible to clarify the subject to the operation guidance.

As can be seen, the present invention shall not be limited to the embodiments described above, and can be modified in various manners within the scope of claims. Obviously, those skilled in the art can arrive at various modifications or amendments within the scope of the claims. That is, technical means may be appropriately modified not to depart from the gist of the present invention, and may be combined into an embodiment. Such an embodiment is included in the technical scope of the present invention.

What is claimed is:

1. An operation guidance assistance system, for an image generation apparatus, operating with an imaging apparatus, the operation guidance assistance system comprising:
a controller executing operation guidance of the image generation apparatus; and
a display displaying the operation guidance,
the controller:
obtaining, when the image generation apparatus develops an error, information on a site of the error with the imaging apparatus;
identifying a member-to-be-operated in accordance with the information on the site of the error in the image generation apparatus, the member-to-be-operated being a subject to the operation guidance for clearing the error;
obtaining, from the information on the site of the error, information on a hand of a user carrying out an operation of the image generation apparatus;
displaying, on the display; the information on the site of the error including the information on the hand of the user; and
displaying operation guidance assistance information to guide the user through the operation in accordance with a sequence of the operation guidance.

2. The operation guidance assistance system according to claim 1, wherein the operation guidance assistance information includes at least any one of: image information indicating the member-to-be-operated; image information indicating a sequence of the operation; image information indicating an operation direction of the member-to-be-operated;
and a caption for the sequence of the operation.

3. The operation guidance assistance system according to claim 1, wherein the controller:
stores, as operation history data, the operation carried out by the user through the operation guidance; and
displays subsequent operation guidance in accordance with the operation history data.

4. The operation guidance assistance system according to claim 1, wherein
when the operation through the operation guidance ends, the controller displays on the display a previously set screen.

5. The operation guidance assistance system according to claim 1, wherein
the controller distinguishes an image region in color to identify the member-to-be-operated and the hand of the user captured with the imaging apparatus.

6. The operation guidance assistance system according to claim 1, wherein
in association with a positional relationship between the member-to-be-operated and the hand of the user, the controller displays on the display a guidance image as the operation guidance assistance information to guide the user through the operation.

7. The operation guidance assistance system according to claim 6, wherein
the controller changes presentation of the guidance image, corresponding to a change in the positional relationship between the hand of the user and the member-to-be-operated.

8. The operation guidance assistance system according to claim 1, wherein
the imaging apparatus is provided to a mobile terminal apparatus separated from the image generation apparatus,
when the imaging apparatus captures the site of the error, the mobile terminal apparatus is capable of pausing a picture for the operation guidance to be displayed on the display of the mobile terminal apparatus, and
the controller:
recognizes positions of the member-to-be-operated and of the hand of the user when the operation guidance paused is resumed; and
resumes the operation guidance at the pause of the operation guidance.

9. The operation guidance assistance system according to claim 1, wherein
the controller notifies the user to capture the image generation apparatus if the controller cannot recognize the image generation apparatus when the imaging apparatus captures the site of the error.

10. The operation guidance assistance system according to claim 9, wherein
if the controller notifies the user that the image generation apparatus be captured, and, after that, recognizes the image generation apparatus, the controller recognizes positions of the member-to-be-operated and of the hand of the user, and executes the operation guidance.

11. An operation guidance assistance system, for an image generation apparatus, operating with an imaging apparatus, the operation guidance assistance system comprising:
a controller executing operation guidance of the image generation apparatus; and
a display displaying the operation guidance,
when a user requests operation guidance of the image generation apparatus, the controller:
identifying a member-to-be-operated in accordance with information requested from the user, the member-to-be-operated being a subject to the operation guidance;
obtaining, with the imaging apparatus, information on a hand of the user operating the image generation apparatus;
displaying, on the display, information on the operation guidance including the information on the hand of the user; and
displaying operation guidance assistance information to guide the user through the operation in accordance with a sequence of the operation guidance.

12. The operation guidance assistance system according to claim 11, wherein
the operation guidance assistance information includes at least any one of: image information indicating the member-to-be-operated; image information indicating a sequence of the operation; image information indicating an operation direction of the member-to-be-operated; and a caption for the sequence of the operation.

13. The operation guidance assistance system according to claim 11, wherein
the controller:
stores, as operation history data, the operation carried out by the user through the operation guidance; and
displays subsequent operation guidance in accordance with the operation history data.

14. The operation guidance assistance system according to claim 11, wherein
when the operation through the operation guidance ends, the controller displays on the display a previously set screen.

15. The operation guidance assistance system according to claim 11, wherein
the controller distinguishes an image region in color to identify the member-to-be-operated and the hand of the user.

16. The operation guidance assistance system according to claim 11, wherein
in association with a positional relationship between the member-to-be-operated and the hand of the user, the controller displays a guidance image as the operation guidance assistance information to guide the user through the operation.

17. The operation guidance assistance system according to claim 16, wherein
the controller changes presentation of the guidance image, corresponding to a change in the positional relationship between the hand of the user and the member-to-be-operated.

18. A method for assisting operation guidance, for an image generating apparatus, with an imaging apparatus, the method comprising:
obtaining, when the image generation apparatus develops an error, information on a site of the error with the imaging apparatus;
identifying a member-to-be-operated in accordance with the information on the site of the error in the image generation apparatus, the member-to-be-operated being a subject to the operation guidance for clearing the error;
obtaining, from the information on the site of the error, information on a hand of a user carrying out an operation of the image generation apparatus;
displaying the information on the site of the error including the information on the hand of the user; and
displaying operation guidance assistance information to guide the user through the operation in accordance with a sequence of the operation guidance.
